(19) United States
(12) Patent Application Publication
(10) Pub. No.: US 2026/0308422 A1
(43) Pub. Date: Oct. 8, 2026

(54) Pressure Sensitive Adhesive Compositions Comprising Polymerized Amide Monomers, Articles, and Methods

(71) Applicant: 3M INNOVATIVE PROPERTIES COMPANY, St. Paul, MN (US)

(72) Inventors: Hyunki Kim, Woodbury, MN (US); Jason D. Clapper, Lino Lakes, MN (US); Kevin M. Lewandowski, Inver Grove Heights, MN (US); Jeffrey Ting, Katy, TX (US); Hengxi Yang, St. Paul, MN (US); Chun-Yi Ting, Taoyuan (TW); Tabitha A. Silliman, Woodbury, MN (US)

(21) Appl. No.: 18/998,313

(22) PCT Filed: Jul. 18, 2023
(86) PCT No.: PCT/IB2023/057336

§ 371 Date: Jan. 24, 2025

Related U.S. Application Data
(60) Provisional application No. 63/401,852, filed on Aug. 29, 2022.

(51) Int. Cl. C09J 7/38

(52) U.S. Cl. CPC C09J 7/385; C09J 2301/302; C09J 2301/414; C09J 2301/416

(57) ABSTRACT

Adhesive compositions are described comprising (e.g. polymerized units of) amide monomer selected from the group N consisting of i) CH₂═CR⁴C(O)NHC(R¹R¹)(C(R¹R¹))nC(O)XR³; ii) CH₂═CR⁴C(O)O(CH₂)₂NHC(O)NHR³; wherein n is an integer of 0 or 1; R¹ is independently selected from hydrogen, alkyl, aryl, and alkylaryl having 1-10 carbon atoms; R³ is a group comprising 1-30 carbon atoms, R⁴ is H or CH₃; and X is O or NH; and at least 50 wt. % of (e.g. polymerized units) of one or more other ethylenically unsaturated monomer(s).

### BACKGROUND

Various adhesive compositions are known. U.S. Pat. No. 10,941,321 describes an adhesive composition comprising a second monomeric unit of the following formula

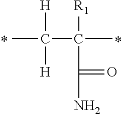

wherein R₁ is hydrogen or methyl. Such second monomeric unit is derived from the monomer acrylamide or methacrylamide. The amount of the second monomer unit can be up to 10 weight percent. Notably acrylamide has been reported in the literature as having a glass transition temperature (Tg) of 165° C.

### SUMMARY

Industry would find advantage in adhesive compositions that exhibit low creep compliance comprising other amide monomers that have a lower Tg.

In some embodiments, adhesive compositions are described comprising: (e.g. polymerized units of) amide monomer selected from the group consisting of

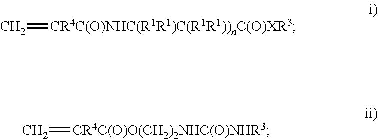

wherein n is an integer of 0 or 1;
R¹ is independently selected from hydrogen, alkyl, aryl, and alkylaryl having 1-10 carbon atoms;
R³ is a group comprising 1-30 carbon atoms,
R⁴ is H or CH₃; and
X is O or NH; and
at least 50 wt. % of (e.g. polymerized units) of one or more other ethylenically unsaturated monomer(s).

The adhesive composition may be a heat activatable adhesive, a UV activatable adhesive, or a pressure sensitive adhesive.

In another embodiment, an article is described comprising a first substrate and a layer of the curable or cured adhesive composition as described herein. The substrate may be for example, a release liner, a polymeric film, or an optical substrate.

In another embodiment, a method of preparing an article is described comprising forming a laminate comprising a first substrate, a second substrate, and a curable adhesive composition layer, as described herein, between the first and second substrate; and exposing the curable adhesive composition layer to (e.g. ultraviolet or visible light) actinic radiation to form a cured adhesive composition layer.

The amide monomers of i) and ii) generally comprise an alkylene (or alkene) moiety having a greater number of carbon atoms that acrylamide or methacrylamide. The presence of this moiety can provide better compatibility with low Tg monomers and is amenable to providing adhesive compositions with a lower Tg.

### DETAILED DESCRIPTION

Presently described are adhesive compositions prepared from a polymerizable composition comprising at least two ethylenically unsaturated monomers, one or more amide monomers and one or more other (i.e. different) ethylenically unsaturated monomers. In some embodiments, the adhesive composition may be a (e.g. homogeneous) mixture of monomers, such as in the case of a liquid (optically clear) adhesive. In other embodiments, the adhesive composition may comprise a random (meth)acrylic polymer formed by partially curing the (e.g. homogeneous) mixture of monomers. In yet other embodiments, the adhesive may comprise a fully cured (e.g. homogeneous) mixture of monomers.

The amide monomer comprises an ethylenically unsaturated group, a terminal group comprising 2 to 30 carbon atoms, and a (e.g. contiguous) amide group between the ethylenically unsaturated group and terminal group. An amide group has a nitrogen atom attached to a carbonyl. In some embodiments, the amide group is part of a urea group. Such amid& has two —NH₂ groups joined by a carbonyl (C═O).

The second amide monomers typically have a structure according to the following formulas:

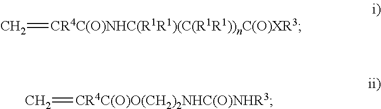

wherein n is an integer of 0 or 1; R¹ is independently selected from hydrogen, alkyl, aryl, and alkylaryl; R³ is a group comprising 2 to 30 carbon atoms; R⁴ is H or CH₃; and X is O or NH.

R³ is typically alkyl, alkene, aryl, alkylaryl, or ether. As used herein, “alkylaryl” refers to a divalent alkylene group bond to a terminal aryl group or a divalent arylene group bonded to a terminal alkyl group. Examples of R³ include, for example, benzyl, phenethyl, phenoxyethyl, phenylpropyl, butyl, pentyl, hexyl, octyl, dodecyl, octadecyl, and phenylbutyl. The alkyl or alkene group may be a straight chain, branched, or comprise a cycloaliphatic moiety. In some embodiments, the terminal group, R³, may comprises at least 3 or 4 carbon atoms. In some embodiments, wherein low haze is required R³ is a (e.g. straight-chain) hydrocarbon that may comprise less than 12, 11, 10, 9, or 8 carbon atoms. However, branched hydrocarbons may have better compatibility and thus also provide low haze.

In some embodiments, R¹ has no greater than 10, 9, 8, 7, 6, 5, 4, 3, 2, or 1 carbon atom. R¹ is most typically aliphatic such as in the case of hydrogen, a methyl, or ethyl. In other embodiments, R¹ is phenyl.

The monomers can be synthesized at room temperature by a nucleophilic reaction between an alkenyl azlactone with a primary amine or alcohol as described in Rasmussen et al. U.S. Pat. No. 10,807,069; incorporated herein by reference.

Representative monomers according to i) are as follows:

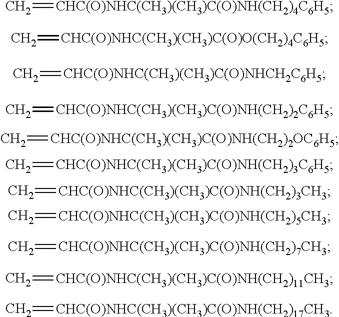

Representative (e.g. urea) monomers according to ii) are as follows:

The adhesive may comprise solely an amide monomer according to the formula of i), solely an amide monomer according to the formula of ii), or combinations of such amide monomers. Combinations include at least two amide monomers of the formula of i), at least two amide monomers of the formula of ii), as well as at least one amide monomer of the formula of i) in combination with at least one of the formula of ii).

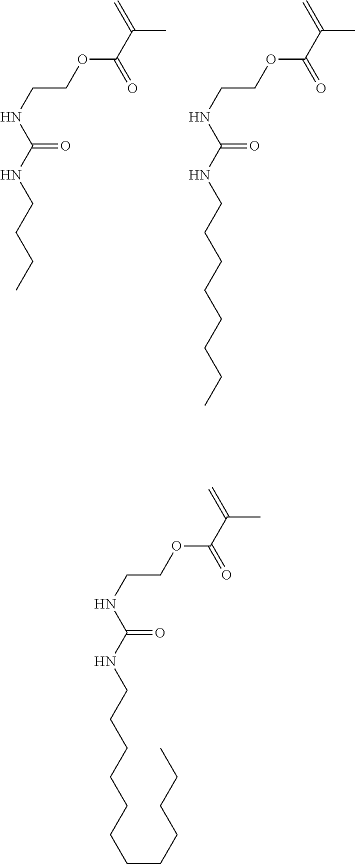 [SMILES: C=C(C)C(=O)OCCNC(=O)NCCCC ; C=C(C)C(=O)OCCNC(=O)NCCCCCCCC ; C=C(C)C(=O)OCCNC(=O)NCCCCCCCCCCCC]

The adhesive composition typically comprises at least 0.5, 1, 1.5, 2, 2.5, 3, 3.5, 4, 4.5 or 5 wt. % of (e.g. polymerized units) or amide monomers according to i), ii) or a mixture thereof based on the total amount of ethylenically unsaturated (e.g. free-radically) polymerizable or polymerized components of the adhesive composition. The amount of i), ii) or a mixture thereof is typically no greater than 30, 25, 20, 15, 10 or 5 wt. %.

In typical embodiments, the adhesive composition typically comprises little or no (e.g. polymerized units of) acrylamide monomer or methacrylamide monomer. Accordingly, adhesive composition comprises little or no polymerized units having the formula

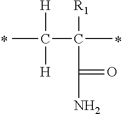

Thus, the amount of such monomers or polymerized units thereof is zero or less than 0.05, 0.01, or 0.001 wt. %, of the total amount of ethylenically unsaturated (e.g. free-radically) polymerizable or polymerized components of the adhesive composition.

The adhesive composition comprises one or more other ethylenically unsaturated monomers, (i.e. that are different than i) and ii). The amount of other ethylenically unsaturated monomers is typically at least 70 wt. % and no greater than 99.5 wt. % of total amount of (e.g. polymerized units) of ethylenically unsaturated (e.g. free-radically polymerizable) components of the adhesive composition. Inorganic fillers as well as non-polymerizable organic components such as plasticizer, tackifier, and organic fillers are not part of the ethylenically unsaturared polymerizable or polymerized components of the adhesive composition. In some embodiments, the amount of other ethylenically unsaturated monomer(s) is at least 70, 75, 80, 85, 90, 95, or 99.5 wt. % of the total amount of (e.g. polymerized units) of ethylenically unsaturated (e.g. free-radically polymerizable) components of the adhesive composition. In some embodiments, the amount of other ethylenically unsaturated monomer(s) is no greater than 99.5, 95, 90, 85, 80, 75, or 70 wt. % of the total amount of (e.g. polymerized units) of ethylenically unsaturated (e.g. free-radically polymerizable) components of the adhesive composition.

In some embodiments, the other ethylenically unsaturated monomers comprises a “(meth)acryloyl” group of formula H₂C═CR₁—(CO)— where R₁ is hydrogen or methyl, such as (meth)acrylate. Polymerized units of (meth)acrylate monomers can be represented by following Formula (I).

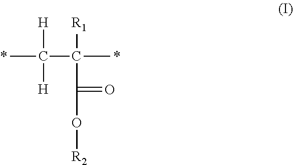

In Formula (I), R₁ is hydrogen or methyl and R₂ is an alkyl, heteroalkyl, aryl, aralkyl, or alkaryl group. Stated differently, the first monomeric unit is derived from an alkyl (meth)acrylate, heteroalkyl (meth)acrylate, aryl (meth)acrylate, aralkyl (meth)acrylate, alkaryl (meth)acrylate, or a mixture thereof (i.e., the (meth)acrylate copolymer can have multiple first monomeric units with different R₂ groups). Suitable alkyl R₂ groups often have 1 to 32 carbon atoms, 1 to 24 carbon atoms, 1 to 18 carbon atoms, 1 to 16 carbon atoms, 1 to 12 carbon atoms, 1 to 10 carbon atoms, 1 to 8 carbon atoms, 1 to 6 carbon atoms, or 1 to 4 carbon atoms. The alkyl groups can be linear, branched, cyclic, or a combination thereof. Suitable heteroalkyl R² groups often have 1 to 30 carbon atoms or more and 1 to 20 carbon atoms or more, 1 to 20 carbon atoms and 1 to 10 heteroatoms, 1 to 16 carbon atoms and 1 to 8 heteroatoms, 1 to 12 carbon atoms and 1 to 6 heteroatoms, or 1 to 10 carbon atoms and 1 to 5 heteroatoms. The heteroatoms are often oxygen (oxy groups) but can be sulfur (—S— groups) or nitrogen (—NH— groups). Suitable aryl R₂ groups typically are carbocyclic aromatic groups. The aryl group often has 6 to 12 carbon atoms or 6 to 10 carbon atoms. In many embodiments, the aryl is phenyl. Suitable aralkyl groups are of formula —R-Ar where R is an alkylene and Ar is an aryl. The alkylene groups, which are a divalent radical of an alkane, typically have 1 to 10 carbon atoms, 1 to 6 carbon atoms, or 1 to 4 carbon atoms and the aryl group typically has 6 to 12 carbon atoms, 6 to 10 carbon atoms, or 6 carbon atoms. In many embodiments, the aryl is phenyl. Suitable alkaryl groups are of formula -Ar-R wherein Ar is an arylene (i.e., a divalent radical of a carbocyclic aromatic compound) and R is an alkyl. The arylene typically has 6 to 12 carbon atoms, 6 to 10 carbon atoms, or 6 carbon atoms. In many embodiments, the arylene is phenylene. The alkyl group of the alkaryl group is the same as described above for alkyl groups but often has 1 to 10 carbon atoms, 1 to 6 carbon atoms, or 1 to 4 carbon atoms.

The R₂ group in Formula (I) often is an alkyl. Stated differently, the first monomeric unit is often derived from (i.e., formed from) an alkyl (meth)acrylate. Exemplary alkyl (meth)acrylates often include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, isoamyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, n-nonyl (meth)acrylate, isononyl (meth)acrylate, isobornyl (meth)acrylate), adamantyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. Some branched alkyl (meth)acrylates are (meth)acrylic acid esters of Guerbet alcohols having 12 to 32 carbon atoms as described in U.S. Pat. No. 8,137,807 (Clapper et al.). In some embodiments, the alkyl (meth)acrylate is chosen that has an alkyl group with no greater than 8 carbon atoms. These alkyl (meth)acrylate often have a higher solubility parameter compared to those having an alkyl group with greater than 8 carbon atoms. This can increase the compatibility with the amide monomer.

Group R₂ can be a heteroalkyl, aryl, aralkyl, or alkaryl group. Examples of monomers with a heteroalkyl (e.g. ether) group include, but are not limited to, ethoxyethoxyethyl (meth)acrylate, polyethylene glycol (meth)acrylate, polypropylene glycol (meth)acrylate, and tetrahydrofurfuryl acrylate. Examples of monomers with a aralkyl group include, but are not limited to, 2-phenylethyl acrylate, 3-phenylethyl acrylate, and 2-biphenylethyl acrylate.

In other embodiments, the adhesive may comprise (e.g. polymerized units) of vinyl monomers. Representative vinyl monomers include for example vinyl esters (e.g., vinyl acetate and vinyl propionate), styrene, substituted styrene (e.g., α-methyl styrene), vinyl halide, N-vinylpyrrolidinone, N-vinyl caprolactam and mixtures thereof.

In some embodiments, the adhesive composition comprises (e.g. polymerized units of) polar monomer(s) including monomers comprising one more hydroxyl groups, monomers comprising one ore more heteroalkyl (e.g. ether) groups, nitrogen-containing monomers (i.e. other than i) and ii)), and acidic monomers.

In some embodiments, the adhesive composition typically comprises at least 10, 15, 20, or 25 wt. % of (e.g. polymerized units of) polar monomer(s) of the total amount of (e.g. polymerized units) of ethylenically unsaturated (e.g. free-radically polymerizable) components of the adhesive composition. In some embodiments, the amount of polar monomer(s) is no greater than 50, 45, 40, 35, 30, 25, 20, 15 or 10 wt. %. Adhesive compositions with sufficiently low amount of polar monomer(s) can have better compatibility with amide monomers of i) or ii) having a higher chain length alky groups such as C12 or greater.

In some embodiments, the polar monomer(s) comprise one or more hydroxyl groups. Representative monomers include hydroxy-substituted alkyl (meth)acrylates, hydroxy-substituted alkyl (meth)acrylamides, hydroxy-substituted heteroalkyl (meth)acrylates, and hydroxy-substituted heteroalkyl (meth)acrylamides. Examples of hydroxy-substituted alkyl (meth)acrylates include, but are not limited to, 2-hydroxyethyl (meth)acrylate, 2-hydroxypropyl (meth)acrylate, 3-hydroxypropyl (meth)acrylate, and 4-hydroxybutyl (meth)acrylate. Hydroxy substituted-alkyl (meth)acrylamides include, but are not limited to, 2-hydroxyethyl (meth)acrylamide and 3-hydroxypropyl (meth)acrylamide. Example hydroxy-substituted heteroalkyl (meth)acrylates include hydroxy-terminated alkylene oxide (meth)acrylate, hydroxy-terminated di(alkylene oxide) (meth)acrylate, and hydroxy-terminated poly(alkylene oxide) (meth)acrylate. The alkylene oxide is typically ethylene oxide or propylene oxide. Specific examples of hydroxy-terminated poly(alkylene oxide) (meth)acrylates include various monomers commercially available from Sartomer (Exton, PA, USA) under the trade designation CD570, CD571, and CD572 and from Geo Specialty Chemicals (Ambler, PA) under the trade designation BISOMER (e.g., BISOMER PPA 6).

In some embodiments, the adhesive composition comprises at least 1, 2, 3, 4, or 5 wt. % of (e.g. polymerized units of) polar monomer(s) with one more hydroxyl groups. In some embodiments, the amount of polar monomer(s) with one more hydroxyl groups is no greater than 35, 30, 25, 20, 15 or 10 wt. % of the total amount of (e.g. polymerized units) of ethylenically unsaturated (e.g. free-radically polymerizable) components of the adhesive composition.

In other embodiments, the adhesive comprises (e.g. polymerized units of) a nitrogen containing monomer. Suitable nitrogen-containing monomeric units include, for example, monomeric units derived from various N-alkyl (meth)acrylamides and N,N-dialkyl (meth)acrylamides can be included such as, N-ethyl (meth)acrylamide, and N,N-diethyl (meth)acrylamide, N-isopropyl (meth)acrylamide, and N-octyl (meth)acrylamide. Other monomeric units derived from various N,N-dialkylaminoalkyl (meth)acrylates and N,N-dialkylaminoalkyl (meth)acrylamides can be included such as, for example, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide. Other examples include monomeric units derived from N-vinyl pyrrolidone, N-morpholino (meth)acrylate, diacetone (meth)acrylamide, and N-vinyl caprolactam. Thus, the adhesive may comprise (e.g. polymerized unit of) an ethylenically unsaturated monomer the comprise a (meth)acrylamide group of the formula H₂C═CR₁—(CO)—NH— that is not acrylamide, methacrylamide, or an amide monomer according to the formulas i) or ii).

In some embodiments, the adhesive composition comprises little or no (e.g. polymerized) acidic polar monomer(s). For example, the polymerizable or cured adhesive composition is free or substantially free of monomeric units derived from (i.e., formed from) (meth)acrylic acid. In other embodiments, the polymerizable or cured adhesive composition is free or substantially free of monomeric units that have groups that can be easily hydrolyzed to provide an acidic group. For example, the polymerizable or cured adhesive composition is free or substantially free of monomeric units derived from anhydride-containing monomers (e.g., maleic anhydride) or vinyl esters (e.g., vinyl acetate). Thus, the amount of such monomers or monomeric units is zero or less than 0.05, 0.01, or 0.001 wt. %, based on the total amount of polymerizable organic components, or polymerized units of the cured (meth)acrylic adhesive composition. Acid monomers can be corrosive especially when the substrate or article comprises metal.

The ethylenically unsaturated monomers are often selected to control the final glass transition temperature (Tg) and shear storage modulus (G′) of the adhesive. In many embodiments, the alkyl (meth)acrylates are alkyl acrylates. The use of alkyl acrylates rather than alkyl methacrylates often results in cured adhesive compositions having a lower glass transition temperature and lower shear storage modulus (G′). The lower glass transition temperature and lower shear storage modulus (G′) properties can provide a pressure-sensitive adhesive (PSA) composition. PSAs are adhesives that satisfy the Dahlquist criteria for tackiness, which means that the shear storage modulus is typically 3×10⁵ Pa (300 kPa) or less when measured at 25° C. and 1 Hertz (6.28 radians/second).

In some embodiments, the adhesive composition comprises at least 30, 35, 40, 45, 50, 55, 60, 65, 70, 75, 80, 85, 90, 95, or 99.5 wt. % of other (e.g. low Tg) ethylenically unsaturated monomer(s) wherein a homopolymer of such monomer has a glass transition temperature (Tg) of less than 25° C. or 0° C. In some embodiments, the adhesive composition comprises no greater than 99.5, 95, 90, 85, 80, 75, 70, 65, 60, 55, 50, 45, 40, 35, or 30 wt. % of low Tg monomer(s). Pressure sensitive adhesive compositions typically comprise a sufficient amount of low Tg ethylenically unsaturated monomer(s) such that the adhesive has a Tg less than 25° C. or 0° C. The Tg of various ethylenically unsaturated monomers is reported in the literature. See for example WO2016/094277; incorporated herein by reference.

In some embodiments, the adhesive composition comprises at least 30, 35, 40, 45, 50, 55, 60, 65, 70, 75, 80, 85, 90, 95, or 99.5 wt. % of other (e.g. higher Tg) ethylenically unsaturated monomer(s) wherein a homopolymer of such monomer has a glass transition temperature (Tg) of greater than 25° C. or 50° C. In some embodiments, the adhesive composition comprises no greater than 99.5, 95, 90, 85, 80, 75, 70, 65, 60, 55, 50, 45, 40, 35, or 30 wt. % of higher Tg monomer(s). Pressure sensitive adhesives comprising higher Tg ethylenically unsaturated monomer(s) may further comprise tackifier, plasticizer, or mixtures thereof to lower the Tg and storage modulus of the adhesive composition.

In some embodiments, the polymerizable or cured adhesive composition comprises little or (e.g. polymerized) monomers having an aromatic group (with the exception of photoinitiators). Illustrative aromatic monomers include, but are not limited to, 2-phenoxyethyl acrylate (available under the trade designation SR339 from Sartomer (Exton, PA)), 2-(phenylthio)ethyl acrylate, 2-phenylphenoxyethyl acrylate (available from Double Bond Chemical Ind. Co. (Taipei, Taiwan)), propionic acid (3-phenoxyphenyl)methyl ester (available from Miwon Chemicals Co. (Korea)). These (higher refractive index) monomeric units may negatively impact optical clarity. Thus, the amount of such monomers or monomeric units is zero or less than 0.05, 0.01, or 0.001 wt. %, based on the total amount of polymerizable organic components, or polymerized units of the cured (meth)acrylic adhesive composition.

The amide monomers as well as the low Tg, high Tg, and polar ethylenically unsaturated monomers are typically monofunctional, i.e. comprising a single (e.g. free-radically) polymerizable group.

The adhesive composition may also comprise (e.g. polymerized units) of ethylenically unsaturated monomers comprises two or more ethylenically unsaturated (e.g. (meth)acryloyl) groups. These monomers can be added to adjust the crosslink density of the cured (meth)acrylate copolymer. These monomers can react with pendant (meth)acryloyl groups of the curable (meth)acrylate copolymers when exposed to ultraviolet or visible light radiation in the presence of a photoinitiator. If added, the amount of these monomeric materials is typically in the range of 0 to 30 wt. % of the total amount of (e.g. polymerized) ethylenically unsaturated monomers. The amount can be at least 1, 2, 3, 4, or 5 wt. % and no greater than 25, 20, 15, or 10 wt. % of the total amount of (e.g. polymerized) ethylenically unsaturated monomers.

Monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate (e.g., commercially available from Sartomer under the trade designation SR-210, SR-252, and SR-603), polypropylene glycol diacrylate, polyethylene/polypropylene copolymer diacrylate, neopentylglycol hydroxypivalate diacrylate modified caprolactone, and polyurethane diacrylates (e.g., commercially available from Sartomer under the trade designation CN9018 and CN983).

Monomers with three or four (meth)acryloyl groups include, but are not limited to, trimethylolpropane triacrylate (e.g., commercially available under the trade designation TMPTA from Allnex, Alpharetta, GA), and under the trade designation SR-351 from Sartomer, Exton, PA), pentaerythritol triacrylate (e.g., commercially available under the trade designation SR-444 from Sartomer), tris(2-hydroxyethylisocyanurate) triacrylate (commercially available under the trade designation SR-368 from Sartomer), a mixture of pentaerythritol triacrylate and pentaerythritol tetraacrylate (e.g., commercially available from Allnex under the trade designation PETIA with an approximately 1:1 ratio of tetraacrylate to triacrylate, and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). An exemplary crosslinker with five (meth)acryloyl groups includes, but is not limited to, dipentaerythritol pentaacrylate (e.g., commercially available under the trade designation SR-399 from Sartomer).

The polymerizable composition typically comprises a free radical initiator to commence polymerization of the monomers. The free radical initiator can be a photoinitator or a thermal initiator. The amount of the free radical initiator is often in a range of 0.05 to 5 weight percent based on a total weight of monomers used.

Suitable thermal initiators include various azo compound such as those commercially available under the trade designation VAZO from Chemours (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile)) and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Arkema (King of Prussia, PA) under the trade designation LUPEROX (e.g., LUPEROX 101, which is 2,5-bis(tert-butylperoxy)-2,5-dimethylhexane, and LUPEROX 130, which is 2,5-dimethyl-2,5-di-(tert-butylperoxy)-3-hexyne); various hydroperoxides such as tert-amyl hydroperoxide and tert-butyl hydroperoxide; and mixtures thereof.

In many embodiments, the free-radical initiator is a photoinitiator, such as photoinitiators comprising an aromatic ketone group. When exposed to ultraviolet radiation, the aromatic ketone group can abstract a hydrogen atom from another polymeric chain or from another portion of the polymeric chain. This abstraction results in the formation of radicals that can subsequently combine to form crosslinks between polymeric chains or within the same polymeric chain. In many embodiments, the aromatic ketone group is an aromatic ketone group such as, for example, a derivative of benzophenone, acetophenone, or anthroquinone. Representative photoinitiators include for example 4-(meth)acryloyloxybenzophenone, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone, and 4-acryloyloxyethoxy-4′-bromobenzophenone.

Other photoinitiators are benzoin ethers (e.g., benzoin methyl ether or benzoin isopropyl ether) or substituted benzoin ethers (e.g., anisoin methyl ether). Other photoinitiators are substituted acetophenones such as 2,2-diethoxyacetophenone or 2,2-dimethoxy-2-phenylacetophenone (commercially available under the trade designation Omnirad BDK from IGM Resins Inc. (Charlotte, NC, USA) or under the trade designation ESACURE KB-1 from Sartomer (Exton, PA, USA)). Still other photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation Omnirad 184), bis(2,4,6-trimethylbenzoyl)phenylphosphineoxide (commercially available under the trade designation Omnirad 819), ethyl(2,4,6-trimethylbenzoyl)-phenyl phosphinate (commercially available under the trade designation Omnirad TPO-L), 1-[4-(2-hydroxyethoxy)phenyl]-2-hydroxy-2-methyl-1-propane-1-one (commercially available under the trade designation Omnirad 2959), 2-benzyl-2-dimethylamino-1-(4-morpholinophenyl)butanone (commercially available under the trade designation Omnirad 369), 2-methyl-1-[4-(methylthio)phenyl]-2-morpholinopropan-1-one (commercially available under the trade designation Omnirad 907), and 2-hydroxy-2-methyl-1-phenyl propan-1-one (commercially available under the trade designation Omnirad 1173 from IGM Resins Inc. The polymerizable composition may optionally further contain a chain transfer agent to control the molecular weight of the cured adhesive. Examples of useful chain transfer agents include, but are not limited to, carbon tetrabromide, alcohols (e.g., ethanol and isopropanol), mercaptans or thiols (e.g., lauryl mercaptan, butyl mercaptan, tert-dodecyl mercaptan, ethanethiol, isooctylthioglycolate, 2-ethylhexyl thioglycolate, 2-ethylhexyl mercaptopropionate, ethyleneglycol bisthioglycolate), and mixtures thereof. If used, the polymerizable mixture may include up to 1 weight percent of a chain transfer agent based on a total weight of monomers. The amount can be up to 0.5 weight percent, up to 0.3 weight percent, up to 0.2 weight percent, or up to 0.1 weight percent and is often equal to at least 0.005 weight percent, at least 0.01 weight percent, at least 0.05 weight percent, or at least 0.1 weight percent. For example, the polymerizable composition can contain 0.005 to 0.5 weight percent, 0.01 to 0.5 weight percent, 0.05 to 0.2 weight percent, 0.01 to 0.2 weight percent, or 0.01 to 0.1 weight percent chain transfer agent based on the total weight of monomers.

The polymerizable composition can further include other components such as, for example, antioxidants and/or stabilizers such as hydroquinone monomethyl ether (p-methoxyphenol, MeHQ), and those available under the trade designation IRGANOX 1010 (tetrakis(methylene(3,5-di-tert-butyl-4-hydroxylhydrocinnamate))methane) from BASF Corp. (Florham Park, NJ, USA). If used, an antioxidant and/or stabilizer is typically used in the range of 0.01 percent by weight (weight percent) to 1.0 weight percent, based on the total weight of monomers in the polymerizable composition.

The polymerization of the polymerizable composition can occur in the presence or absence of an organic solvent. If an organic solvent is included in the polymerizable composition, the amount is often selected to provide the desired viscosity to the polymerizable composition and to the polymerized composition. Examples of suitable organic solvents include, but are not limited to, methanol, tetrahydrofuran, ethanol, isopropanol, heptane, acetone, methyl ethyl ketone, methyl acetate, ethyl acetate, toluene, xylene, and ethylene glycol alkyl ether. Those solvents can be used alone or combined as mixtures. In some embodiments, the organic solvent is present in an amount less than 15 weight percent, less than 10 weight percent, less than 8 weight percent, less than 6 weight percent, less than 5 weight percent, or less than 2 weight percent based on the total weight of the polymerizable composition. If used, any organic solvent typically is removed at the completion of the polymerization reaction or during coating. In many embodiments, the polymerization occurs with little or no organic solvent present. That is the polymerizable composition is free of organic solvent or contains a minimum amount of organic solvent.

The monomers can be polymerized by conventional polymerization methods (such as solution polymerization or emulsion polymerization) including thermal bulk polymerization under adiabatic conditions, as is disclosed in U.S. Pat. No. 5,637,646 (Ellis) and U.S. Pat. No. 5,986,011 (Ellis et al.). Other methods include solventless bulk polymerization as described in U.S. Pat. No. 4,181,752 (Martens et al.), continuous free radical polymerization methods described in U.S. Pat. Nos. 4,619,979 and 4,843,134 (Kotnour et al.) and the polymerization within a polymeric package as described in U.S. Pat. No. 5,804,610 (Hamer et al.).

The adhesive composition, comprising partially or completely cured monomer(s)) is sufficiently tacky, as can be characterized by peel strength. If desired, tackifiers can be added to the adhesive composition. Useful tackifiers include, for example, rosin ester resins, aromatic hydrocarbon resins, aliphatic hydrocarbon resins, and terpene resins. In general, light-colored tackifiers selected from hydrogenated rosin esters, hydrogenated terpenes, or hydrogenated aromatic hydrocarbon resins are preferred.

Low molecular weight polymers derived from (meth)acrylates can optionally be combined with the (meth)acrylate copolymer. Suitable low molecular weight polymers are described, for example, in U.S. Pat. No. 6,783,850 (Takizawa et al.), U.S. Pat. No. 6,448,339 (Tomita), U.S. Pat. No. 4,912,169 (Whitmire et al.), and U.S. Pat. No. 6,939,911 (Tosaki et al.). These polymers can function as tackifiers.

Plasticizers may also be used to adjust the rheology of the adhesive composition. The plasticizers may be non-reactive compounds such as phosphate, adipate, and phthalate esters. Various low glass transition temperature (e.g., lower than 0° C.), lower molecular weight (e.g., a Mw less than 100,000 Daltons as determined by GPC) acrylic polymers, prepared similarly to the acrylic tackifiers described above can also be used as plasticizers.

Other optional additives include, for example, antioxidants, UV stabilizers, UV absorbers, pigments, curing agents, and polymer additives. These other optional additives can be selected, if desired, so that they do not significantly reduce the optical clarity of the adhesive composition.

Physical properties of the partially or completely cured adhesive composition can be characterized according to the test methods further described in the examples.

The adhesive composition typically comprises a lower Tg than the same adhesive comprising polymerized units of (meth)acrylamide monomer in place of the claimed amide monomers. However, the Tg of the adhesive can be greater than the same adhesive lacking an amide monomers.

In some embodiments, the final glass transition temperature (Tg) of the (e.g. partially or fully) cured adhesive at least −40° C., −35° C., −30° C., −25° C., −20° C., −15° C., −10° C., −5° C., 0° C. In some embodiments, the final glass transition temperature (Tg) for the (meth)acrylate copolymer is no greater that 40° C., 35° C., 30° C., 25° C., 20° C., 15° C., 10° C., 5° C., or 0° C. When the Tg exceeds 20° C., the adhesive may be characterized as heat-activatable, i.e. upon heating slightly above the Tg, the material becomes tacky and adheres. Upon cooling the below Tg these heat-activated adhesive will no longer be tacky but have sufficient ability to hold onto an adherend and have sufficient cohesive strength to be cleanly removed from the adherend. The glass transition temperature of the adhesive can be measured using Dynamic Mechanical Analysis at a frequency of 1 radian/second as described in the Examples section below.

In some embodiments, the Tan δ at 70° C. of the cured adhesive is less than 1, 0.8, 0.7, 0.6, 0.5, 0.4, 0.3 or 0.2. In some embodiments, the Tan δ at 70° C. of the cured adhesive is greater than 0.1, 0.2, 0.3, 0.4, 0.5, 0.6, or 0.7.

In some embodiments, the cured adhesive has a creep compliance of less than 5000, 4000, 3000, 2000, 1500, or 1000 l/MPa at 1000 seconds. In some embodiments, the cured adhesive has a creep compliance of a least 50, 75, 100, 200, 300, 400 or 500 l/MPa at 1000 seconds.

In some embodiments, the cured adhesive composition has an average peel of at least 1, 2, 3, 4, 5, 10, 15 or 20 N/in (2.54 cm). In some embodiments, the cured adhesive composition has an average peel of no greater than 40, 35, 30, 25, or 20 N/in (2.54 cm).

It is appreciated that the preferred physical properties can be different depending on the end-use of the adhesively bonded article.

In another aspect, an article is provided that includes a first substrate and a layer of the curable adhesive composition adjacent to the first substrate. The layer of the curable adhesive composition is often in the form of a film. As used herein, the term “adjacent” can be used to refer to two materials, typically in the form of layers, that are in direct contact or that are separated by one or more other materials, such as primer or hard coating layers. Often, adjacent materials are in direct contact.

Various methods can be used to form the article. For example, an adhesive composition containing a curable (meth)acrylate copolymer, an optional photoinitiator, and any other optional additives can be coated out of a solvent or from a melt. Such methods are well known to those of skill in the art. If processed out of a coating composition that includes a solvent, a suitable solvent is one that is miscible with the other components of the coating composition. By this, it is meant that the coating composition remains homogeneous in diluted form and during drying such that there is no premature separation of the components out of the solvent. A suitable solvent, if used, is one that can be removed easily from the coated layer. Also, a suitable solvent is one that does not damage the substrate to which the coating composition is applied (for example, it cannot cause crazing of a polymer film). Exemplary solvents include methyl ethyl ketone, methyl isobutyl ketone, 1-methoxy-2-propanol, isopropyl alcohol, toluene, ethyl acetate, butyl acetate, acetone, and the like, and mixtures thereof.

In many embodiments, the article includes a first substrate, a second substrate, and a layer of the curable adhesive composition positioned between the first substrate and the second substrate. The curable (meth)acrylate copolymer within the curable adhesive composition can be cured by exposing the adhesive to heat, ultraviolet or visible light radiation, or a combination thereof. In some embodiments, a curable adhesive composition provided in the form of a layer (e.g., film) that can be stored or transported for later curing by a customer.

In some embodiments of the article, the layer of the curable adhesive composition is a die-cut layer. More particularly, the article can include a die-cut layer positioned between a first substrate and a second substrate. In some specific articles, at least one of the first substrate and the second substrate is a release liner. For example, in some articles, the die-cut layer is positioned between a first release liner and a second release liner. In some other specific articles, the first substrate is a release liner and the second substrate is an optical substrate (e.g., an optical film).

In another aspect, a method of preparing an article is provided. The method includes providing a first substrate, a second substrate, and a curable adhesive composition layer. The method further includes forming a laminate comprising the first substrate, the second substrate, and the curable adhesive composition layer, wherein the adhesive composition layer is positioned between the first substrate and the second substrate. Still further, the method includes exposing the adhesive composition layer to ultraviolet or visible light radiation to cure the (meth)acrylate copolymer.

In some examples, the adhesive compositions can be used in a variety of transfer tapes. The transfer tapes can be made by coating a curable adhesive composition on a differential release liner (i.e., a double-sided release liner where both major surfaces of the liner contain a release coating and the release coatings are different) and optionally can be at least partially cured. The adhesive composition is typically coated onto the side of the liner with the higher release value. After coating, the adhesive-coated release liner is wound into a roll to yield the transfer adhesive. Alternatively, the adhesive composition is coated on a first liner and, if needed, dried. A second liner, which usually has a different release value than the first liner, is positioned adjacent to the adhesive opposite the first liner (the PSA is positioned between the first liner and the second liner). When unwinding the adhesive transfer tape, the adhesive remains attached to the side of the liner with the higher release value. In use, the transfer adhesive is unwound and laminated to a substrate surface (e.g., such as those in optics-related devices as disclosed in greater detail below, or non-optics-related devices and articles such as painted panels, metal panels, window glass, automotive panels, etc.). The transfer adhesive has higher adhesion to the substrate surface than to the release liner and thus is transferred from the release liner to the substrate surface.

Representative examples of optically clear substrates include glass and polymeric substrates including those that contain polycarbonates, polyesters (e.g., polyethylene terephthalates and polyethylene naphthalates), polyimides, polyurethanes, poly(meth)acrylates (e.g., poly(methyl methacrylates)), polyvinyl alcohols, polyolefins (e.g., polyethylenes, polypropylenes, and cyclic olefin copolymers), and cellulose triacetates. Typically, cover lenses can be made of glass, poly(methyl methacrylates), or polycarbonate.

Suitable liners include flexible backing materials conventionally used as a tape backing, optical film, or release liner. In general, any suitable flexible material can be used without specific limitations on its refractive index or optical clarity since it is removed and does not become part of the article that includes the display substrate. Typical examples of flexible backing materials used as tape backings that may be useful for the laminates described herein include those made of paper (e.g., Kraft paper) or polymeric films such as polypropylene, polyethylene, polyurethane, polyester (e.g., polyethylene terephthalate), ethylene vinyl acetate, cellulose acetate, and ethyl cellulose. Some flexible backings may have coatings. For example a release liner may be coated with a low adhesion component, such as a silicone-containing material or a fluorocarbon-containing material.

In some favored embodiments, the curable or cured adhesive compositions are optically clear. Thus, certain articles can be laminates that include an optically clear substrate (e.g., an optical substrate such as an optical film) and an optically clear adhesive layer of the cured or curable adhesive composition adjacent to at least one major surface of the optically clear substrate. The laminates can further include a second substrate permanently or temporarily attached to the adhesive layer and with the adhesive layer being positioned between the optically clear substrate and the second substrate. As used herein, optically clear refer to an adhesive layer (having a thickness of 50 microns), the substrate(s), or the combination thereof having a haze less than 5, 4, 3, 2, or 1%. The adhesive layer, substrate(s), and combination thereof typically has a transmission of visible light of at least 85 or 90% The haze and transmission can be measured according to the test method described in the examples.

Illustrative (e.g. optically clear) substrates include inorganic substrates, such as glass, as well as organic substrates such as polyethylene terephthalate, cyclo-olefin copolymer, polycarbonate, cellulose triacetate, poly(methyl methacrylate), or another polyacrylate. In certain embodiments, the substrate is, or is part of, a lens, a touch sensor, a light emissive display, a light reflective display, or a polarizer film, for example.

Exemplary optical substrates include (or are included as a part of) a display panel, such as a liquid crystal display, an OLED display, a touch panel, an electrophoretic display, an electrowetting display or a cathode ray tube, a window or glazing, an optical component such as a reflector, polarizer, diffraction grating, mirror, or cover lens, or another film such as a decorative film or optical film. In some embodiments, the optical substrates can be optically clear.

In some example laminates, an optically clear adhesive layer (i.e., a cured or curable adhesive composition described herein) is positioned between two substrates and at least one of the substrates is an optical film, a display unit, a touch sensor, or a lens. Optical films intentionally enhance, manipulate, control, maintain, transmit, reflect, refract, absorb, retard, or otherwise alter light that impinges upon a surface of the optical film. Optical films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Optical films for the provided laminates can also include retarder plates such as quarter-wave and half-wave phase retardation optical elements. Other optically clear films can include anti-splinter films and electromagnetic interference filters. The films may also be used as substrates for ITO (i.e., indium tin oxide) coating or patterning, such as use those used for the fabrication of touch sensors.

In some embodiments, laminates that include a curable or cured adhesive as describe herein can be optical elements, or can be used to prepare optical elements. As used herein, the term “optical element” refers to an article that has an optical effect or optical application. The optical elements can be used, for example, in electronic displays (e.g., liquid crystal displays (LCDs), organic light emitting displays (OLEDs), architectural applications, transportation applications, projection applications, photonics applications, and graphics applications). Suitable optical elements include, but are not limited to, glazing (e.g., windows and windshields), screens or displays, polarizing beam splitters, cathode ray tubes, ITO-coated touch sensors such as those using glass or clear plastic substrates, and reflectors.

The optically clear adhesive compositions are suitable for electronic display assemblies.

In some embodiments, the adhesive is suitable for gap filling between an outer cover lens or sheet (e.g., such as those based on glass, polyethylene terephthalate, polycarbonate, poly(methyl methacrylate), cyclic olefin copolymer, and the like) and an underlying display module of an electronic display assembly. The presence of the adhesive improves the performance of the display by reducing the refractive index mismatch between substrates and the air gap while also providing structural support to the assembly. Filling the gap with an index matching adhesive reduces sunlight and ambient light reflections inherent in the use of multi-layered display panels; as a result, contrast and brightness of conventional display panels are improved.

In some embodiments, layers of adhesive as described herein, either as a liquid optically clear adhesive (LOCA) or as an optically clear adhesive film (e.g., a die-cut film, which can be referred to as a contrast enhancement film (CEF)) can be used to assemble the top layers of the display module. For example, during the manufacture of certain display devices two rigid substrates, such as a liquid crystal display (LCD) and a glass or polycarbonate cover lens, are optically coupled by an adhesive. In many cases, a (e.g. capacitive) touch sensor is also introduced between the LCD and the cover lens.

In other embodiments, the adhesive is laminated between a printed lens (i.e., the lens has printed ink-steps) and a second display substrate. In this embodiment, the curable adhesive composition may conform to a large ink-step (i.e., 20-100 or 50-100 micrometers or even higher) with the total adhesive

In addition to various optics-related applications and/or electronic display assembly applications, both the curable and cured adhesive compositions can be used in a variety of other applications. For example, the article can comprise a partially (e.g. UV) cured adhesive layer (e.g., film) on a backing or release liner. If a release liner is used, the layer can be transferred to another substrate. The other substrate can be, for example, a component of an electronic display assembly. That is, the layer can be laminated to another substrate. The film is often laminated between a first substrate and a second substrate (i.e., the layer of curable adhesive is positioned between the first substrate and the second substrate). V/hen the partially (e.g. UV) cured (e.g. pressure sensitive) adhesive layer can be cured by exposure to heat or light. Once cured, the adhesive layer may or may not be a pressure sensitive adhesive depending on the final modulus.

The invention is further illustrated by the following examples.

### EXAMPLES

Unless otherwise noted or readily apparent from the context, all parts, percentages, ratios, etc. in the Examples and the rest of the specification are by weight.

### Materials Used in the Examples

| Abbreviation | Description and Source |
|---|---|
| MUC4 | Methacryloyloxy ethyl butyl urea, prepared |
| | in Preparatory Example 1 disclosed herein. |
| MUC8 | Methacryloyloxy ethyl octyl urea, prepared |
| | in Preparatory Example 2 disclosed herein. |
| MUC12 | Methacryloyloxy ethyl dodecyl urea, prepared |
| | in Preparatory Example 3 disclosed herein. |
| AUC4 | Acryloyloxy ethyl butyl urea, prepared in |
| | Preparatory Example 4 disclosed herein. |
| VDM-C4Am | Acylamidoisopropyl butylamide, prepared |
| | in Preparatory Example 5 disclosed herein. |
| VDM-C12Am | Acylamidoisopropyl dodecylamide, prepared |
| | in Preparatory Example 6 disclosed herein. |
| ACM | Acrylamide, obtained from Alfa Aesar, |
| | Haverhill, Massachusetts, United State |
| IEM | Isocyanate ethyl methacrylate, obtained |
| | from Showa Denko, Tokyo, Japan |
| IEA | Isocyanate ethyl acrylate, obtained from |
| | Showa Denko, Tokyo, Japan |
| VDM | 2-vinyl-4,4-dimethyl azlactone, prepared |
| | according to U.S. Pat. No. 4,304,705 |
| BA | N-butylamine, obtained from TCI America, |
| | Portland, Oregon, United States |
| OA | N-octylamine, obtained from Alfa Aesar, |
| | Haverhill, Massachusetts, United States |
| DA | N-dodecylamine, obtained from TCI America, |
| | Portland, Oregon, United States |
| HEA | 2-hydroxyethyl acrylate, obtained from |
| | KOWA America Corporation, New York, |
| | New York, United States |
| EHA | 2-ethylhexyl acrylate, obtained from BASF, |
| | Florham Park, New Jersey, United States |
| THFA | Tetrahydrofurfuryl acrylate, obtained from |
| | TCI America, Portland, Oregon, United States |
| EHMA | 2-ethylhexyl methacrylate, obtained from |
| | Lucite International, Memphis, Tennessee, |
| | United States |
| HDDA | Hexanediol Diacrylate, Alfa Aesar, |
| | Ward Hill, MA |
| HMP | 2-hydroxy-2-methylpripiophenone, TCI America, |
| | Portland, Oregon, United States |
| GPTMS | (3-Glycidoxypropyl)trimethoxysilane from Alfa |
| | Aesar, Haverhill, Massachusetts, United States |
| TPO | Diphenyl(2,4,6-trimethylbenzoyl)phosphine |
| | oxide, obtained from IGM Resins USA Inc., |
| | Charlotte, North Carolina, United States |
| I651 | 2,2-dimethoxy-2-phenylacetophenone, obtained |
| | under the trade designation “IRGACURE 651” |
| | from Alfa Aesar, Haverhill, Massachusetts, |
| | United States |
| I819 | Bis(2,4,6-trimethylbenzoyl)phenylphosphine |
| | oxide), obtained under the trade designation |
| | “OMNIRAD 819” from IGM Resins USA Inc., |
| | Charlotte, North Carolina, United States |
| Allyl-3 | Triallyl isocyanurate, obtained from TCI |
| | America, Portland, Oregon, United States |
| CHCl₃ | Chloroform, obtained from VWR International, |
| | Radnor, Pennsylvania, United States |
| EtOAc | Ethyl acetate, obtained from VWR International, |
| | Radnor, Pennsylvania, United States |
| RF02N | Easy side siliconized PET film release liner, |
| | available from SKC Hass, Seoul, South Korea |
| RF22N | Tight side siliconized PET film release liner, |
| | available from SKC Hass, Seoul, South Korea |

### Test Methods

Dynamic Mechanical Analysis—A TA Instrument rheometer (TA Instruments, Eden Prairie, Minnesota) was used to measure terminal viscosity, glass transition temperature (Tg), and Tan δ values in oscillatory shear mode, using adhesive films with stacked thickness of approximately 1 mm. The adhesive films were punch-cut into a circular disk of 8 mm diameter and located between parallel plates. Tg and Tan δ were measured by temperature sweep mode (frequency equals 1 rad/sec), and creep compliances were measured under 8000 Pa constant shear stress at 25° C. Creep compliance values were recorded at 1000 s.

Optical Properties: Diffusive Transmittance for Haze Characterization—The adhesive film (100 microns thickess) was laminated on glass substrates (1 mm thick LCD glass substrate, Swift Glass, Elmira Heights, New York), and then the adhesive/glass assembly was located to the transmission port of the instrument (UltraScan Pro, Hunterlab, USA). Optical properties including haze % values were recorded in the visible wavelength range of 400 to 700 nm.

1800 Peel Adhesion Test—Adhesive films with a thickness of 0.1 mm were laminated on top of PET film (STCH11, DuPont Teijin Films) with a thickness of 0.05 mm. These Adhesive Film/PET assembly films were cut into 0.5 inch strips and laminated on top of glass substrate. After aging for 1 day, the adhesive films were peeled off with 180 angle using a peel tester (IMASS, Inc., Accord, Massachusetts). Peel speed was set to 12 in/min. Once peel tests were started, initial results (duration=2 sec) were discarded, then recorded for 5 sec. The final peel forces were averaged during this period.

### Preparatory Examples

Preparatory Example 1: Synthesis of MUC4 (C₁₁H₂₀N₂O₃) IEM (15 g, 96.7 mmol) was dissolved in CHCl₃ (50 g, 418 mmol) in a round bottom flask with magnetic stir bar. BA (7.07 g, 96.7 mmol) was dissolved in CHCl₃ (15 g, 126 mmol) in a vial. The IEM solution was set to stir in an ice-water bath and BA solution was added dropwise. The solution was allowed to warm to room temperature and stirred overnight. The resultant solution was concentrated by rotary evaporation, followed by vacuum drying to get solid products. Reaction yield was 97%.

Preparatory Example 2: Synthesis of MUC8 (C₁₅H₂₈N₂O₃) IEM (5 g, 32.2 mmol) was dissolved in CHCl₃ (20 g, 168 mmol) in a round bottom flask with magnetic stir bar. OA (4.17 g, 32.2 mmol) was dissolved in CHCl₃ (15 g, 126 mmol) in a vial. The IEM solution was set to stir in an ice-water bath and OA solution was added dropwise. The solution was allowed to warm to room temperature and stirred overnight. The resultant solution was concentrated by rotary evaporation, followed by vacuum drying to get solid products. Reaction yield was 99%.

Preparatory Example 3: Synthesis of MUC12 (C₁₉H₃₆N₂O₃) IEM (5 g, 32.2 mmol) was dissolved in CHCl₃ (20 g, 168 mmol) in a round bottom flask with magnetic stir bar. DA (5.97 g, 32.2 mmol) was dissolved in CHCl₃ (15 g, 126 mmol) in a vial. The IEM solution was set to stir in an ice-water bath and DA solution was added dropwise. The solution was allowed to warm to room temperature and stirred overnight. The resultant solution was concentrated by rotary evaporation, followed by vacuum drying to get solid products. Reaction yield was 95%.

Preparatory Example 4: Synthesis of AUC4 (C₁₀H₁₈N₂O₃) IEA (15.4 g, 109.1 mmol) was dissolved in CHCl₃ (30 g, 251 mmol) in a round bottom flask with magnetic stir bar. BA (7.98 g, 109.1) was dissolved in CHCl₃ (15 g, 126 mmol) in a vial. The IEA solution was set to stir in an acetone-dry ice bath and BA solution was added dropwise. The solution was allowed to warm to room temperature and stirred overnight. The resultant solution was concentrated by rotary evaporation, followed by vacuum drying to get solid products. White solid was obtained as final product with a reaction yield of 73%.

Preparatory Example 5: Synthesis of MUC3 (C₉H₁₆N₂O₃) IEM (50 g, 322 mmol) was dissolved in dichloromethane (55 g, 645 mmol) in a 250 mL round bottom flask equipped with thermocouple, overhead stirrer, addition funnel, and dry air inlet. The reaction flask was cooled on an ice water bath while n-propylamine (19 g, 322 mmol) was added dropwise, maintaining the batch temperature below 35 C. The solution was allowed to warm to room temperature and stirred overnight. The resultant solution was concentrated by rotary evaporation, followed by vacuum drying to get solid products. Reaction yield was 97%.

### Preparatory Example 6: Synthesis of VDM-C4Am (C₁₁H₂₀N₂O₂)

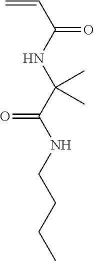

VDM (10.0 g, 71.9 mmol) was dissolved in 50 mL of EtOAc in a round bottom flask with stir bar and set stirring in a cold water bath. BA (5.256 g, 71.9 mmol) was added dropwise over five minutes. The mixture was then warmed to about 40° C. After five minutes at 40° C., the mixture was allowed to cool to room temp and a white solid crystallized. The solid was filtered, washed with heptane, and dried under vacuum. A white flaky solid was obtained with a reaction yield of 75%.

Preparatory Example 7: Synthesis of VDM-C12Am (C₁₉H₃₆N₂O₂) VDM (10.0 g, 71.9 mmol) was dissolved in 75 mL of EtOAc in a round bottom flask with stir bar and set stirring in a cold water bath. DA (13.32 g, 71.9 mmol) was added dropwise over five minutes. The mixture was then warmed to about 35° C. After 30 minutes, the mixture was allowed to cool to room temp and a white solid crystallized. The collected white solid was washed with hexanes two times, then dried under vacuum. The reaction yield was 79%.

### Preparatory Example 8: Polymer Preparation

Polymer compositions SRP-1 and SRP-2 were prepared by partially UV-polymerizing monomer mixtures. SRP-1 comprises of EHA (65 wt. %) and THFA (35 wt. %) with 1651 (0.15 parts per hundred, pph). SRP-2 comprises EHA (72 wt. %), THFA (18 wt. %), and EHMA (10 wt. %) with 1651 (0.15 pph). The reaction mixtures were purged by flowing nitrogen gas into the jar before irradiating with UV light with an output wavelength of 365 nm and an intensity of 0.3 mW/cm² until a viscous solution of approximately 2,000 cP was achieved.

### EXAMPLES

### Preparation of Examples E1 to E11 and Comparative Example CE1 to CE4

To polymer composition SRP-1 was added 8 pph of a solution of 20 wt. % TPO in HEA yielding a premix SPM-1. To SPM-1 was added amide or urea monomer solution (20 wt. % urea monomer in HEA) according to Table 2, wherein the amounts are relative to SPM-1 being 100 pph. The mixed solutions were coated between RF02N and RF22N release liners at 0.1 mm coating thickness and further polymerized using a light source with an output wavelength at 405 nm (1600 mJ/cm²) to form the adhesive film. Adhesive films were tested according to the test methods above with the results in Table 4.

### Preparation of Examples E12 to E20 and Comparative Example CE5 to CE7

To SRP-2 was added amide or urea monomer solution (20 wt. % amide or urea monomer in HEA) according to Table 2, wherein the amounts are relative to SRP-2 being 100 pph, yielding a premix SPM-2. To SPM-2 was added 1819 (1 pph) and a 50 wt. % solution of Allyl-3 in THFA (3 pph), wherein the amounts are relative to SPM-2 being 100 pph. The mixed solutions were coated between RF02N and RF22N release liners at 0.1 mm coating thickness and further polymerized using a light source with an output wavelength at 405 nm (880 mJ/cm²) to form the adhesive film. Adhesive films were tested according to the test methods above with the results in Table 4.

### Preparation of Example E21

A polymer solution was generated by mixing 234 g 2EHA, 43.6 g 2EHMA, 50.4 g HEA, 32 g MUC3, and 0.22 g HMP in a clear glass jar. The jar was then purged by flowing nitrogen gas into the jar before irradiating with UV light with an output wavelength of 365 nm and an intensity of 0.3 mW/cm² until a viscous solution of approximately 2,000 cP was achieved. To the polymer solution, 0.36 g of HDDA, 0.9 g 1651, and 0.18 g GPTMS was mixed into the jar. The mixed solutions were coated between RF02N and RF22N release liners at 0.1 mm coating thickness and further polymerized using a light source with an output wavelength at 365 nm (2280 mJ/cm²) to form the adhesive film. Adhesive films were tested according to the test methods above with the results in Table 4.

TABLE 2
Adhesive Compositions

| | | | Amide or Urea |
|---|---|---|---|
| | | Amide or Urea | Monomer |
| Sample | Premix | Monomer | Solution (pph) |
| CE1 | SPM-1 | — | — |
| E1 | SPM-1 | MUC4 | 10 |
| E2 | SPM-1 | MUC4 | 20 |
| E3 | SPM-1 | MUC4 | 30 |
| E4 | SPM-1 | MUC4 | 40 |
| E5 | SPM-1 | AUC4 | 10 |
| E6 | SPM-1 | AUC4 | 20 |
| E7 | SPM-1 | AUC4 | 30 |
| E8 | SPM-1 | MUC8 | 10 |
| E9 | SPM-1 | MUC8 | 20 |
| E10 | SPM-1 | MUC8 | 30 |
| E11* | SPM-1 | MUC12 | 30 |
| CE2 | SPM-1 | ACM | 10 |
| CE3 | SPM-1 | ACM | 20 |
| CE4 | SPM-1 | ACM | 30 |
| CE5 | SRP-2 | — | — |
| E12 | SRP-2 | VDM-C4Am | 11 |
| E13 | SRP-2 | VDM-C4Am | 25 |
| E14 | SRP-2 | VDM-C4Am | 43 |
| E15 | SRP-2 | MUC4 | 11 |
| E16 | SRP-2 | MUC4 | 25 |
| E17 | SRP-2 | MUC4 | 43 |
| E18 | SRP-2 | VDM-C12Am | 11 |
| E19* | SRP-2 | VDM-C12Am | 25 |
| E20* | SRP-2 | VDM-C12Am | 43 |
| CE6 | SRP-2 | ACM | 11 |
| CE7 | SRP-2 | ACM | 25 |

*Composition exhibited phase separation and thus were not subjected to adhesive testing. However, amide monomers with a C12 group could be compatible in a different adhesive composition comprising less polar monomer (e.g. THFA, HEA).

TABLE 3
Wt. % of Materials of Polymerized Composition

| | | | | | Amide | | | | | |
|---|---|---|---|---|---|---|---|---|---|---|
| | | | | | or Urea | | | | | |
| Sample | EHA | THFA | EHMA | HEA | Monomer | I651 | TPO | HDDA | Allyl-3 | I819 |
| CE1 | 60.1 | 32.4 | — | 5.9 | — | 0.14 | 1.5 | | — | — |
| E1 | 54.6 | 29.4 | — | 12.7 | 1.8 | 0.13 | 1.3 | | — | — |
| E2 | 50.1 | 27.0 | — | 18.3 | 3.3 | 0.12 | 1.2 | | — | — |
| E3 | 46.2 | 24.9 | — | 23.0 | 4.6 | 0.11 | 1.1 | | — | — |
| E4 | 42.9 | 23.1 | — | 27.1 | 5.7 | 0.10 | 1.1 | | — | — |
| E5 | 54.6 | 29.4 | — | 12.7 | 1.8 | 0.13 | 1.3 | | — | — |
| E6 | 50.1 | 27.0 | — | 18.3 | 3.3 | 0.12 | 1.2 | | — | — |
| E7 | 46.2 | 24.9 | — | 23.0 | 4.6 | 0.11 | 1.1 | | — | — |
| E8 | 54.6 | 29.4 | — | 12.7 | 1.8 | 0.13 | 1.3 | | — | — |
| E9 | 50.1 | 27.0 | — | 18.3 | 3.3 | 0.12 | 1.2 | | — | — |
| E10 | 46.2 | 24.9 | — | 23.0 | 4.6 | 0.11 | 1.1 | | — | — |
| E11 | 46.2 | 24.9 | — | 23.0 | 4.6 | 0.11 | 1.1 | | — | — |
| CE2 | 54.6 | 29.4 | — | 12.7 | 1.8 | 0.13 | 1.3 | | | |
| CE3 | 50.1 | 27.0 | — | 18.3 | 3.3 | 0.12 | 1.2 | | | |
| CE4 | 46.2 | 24.9 | — | 23.0 | 4.6 | 0.11 | 1.1 | | | |
| CE5 | 70.5 | 17.9 | 9.8 | 0.0 | 0.0 | 0.15 | | | 0.73 | 0.98 |
| E12 | 63.4 | 16.2 | 8.8 | 7.8 | 2.0 | 0.13 | | | 0.73 | 0.98 |
| E13 | 56.4 | 14.5 | 7.8 | 15.6 | 3.9 | 0.12 | | | 0.73 | 0.98 |
| E14 | 49.3 | 12.7 | 6.9 | 23.4 | 5.9 | 0.1 | | | 0.73 | 0.98 |
| E15 | 63.4 | 16.2 | 8.8 | 7.8 | 2.0 | 0.13 | | | 0.73 | 0.98 |
| E16 | 56.4 | 14.5 | 7.8 | 15.6 | 3.9 | 0.12 | | | 0.73 | 0.98 |
| E17 | 49.3 | 12.7 | 6.9 | 23.4 | 5.9 | 0.1 | | | 0.73 | 0.98 |
| E18 | 63.4 | 16.2 | 8.8 | 7.8 | 2.0 | 0.13 | | | 0.73 | 0.98 |
| E19 | 56.4 | 14.5 | 7.8 | 15.6 | 3.9 | 0.12 | | | 0.73 | 0.98 |
| E20 | 49.3 | 12.7 | 6.9 | 23.4 | 5.9 | 0.1 | | | 0.73 | 0.98 |
| E21 | 65.5 | | 11.8 | 13.7 | 8.7 | 0.25 | | 0.10 | | |
| CE6 | 63.4 | 16.2 | 8.8 | 7.8 | 2.0 | 0.13 | | | 0.73 | 0.98 |
| CE7 | 56.4 | 14.5 | 7.8 | 15.6 | 3.9 | 0.12 | | | 0.73 | 0.98 |

TABLE 4
Optical, Mechanical, and Adhesive Properties of Adhesive Films

| | Dynamic mechanical | | | Creep | | |
|---|---|---|---|---|---|---|
| | properties | | | properties | | |
| | Tg | Tan δ at | Optical | Compliance at | Peel (N/in) | |
| Sample | (° C.) | 70° C. | Haze % | 1000 s (1/MPa) | Average | Stdev |
| CE1 | −25.2 | 1.2 | 0.7 | 6414 | 23.76 | 0.86 |
| E1 | −22.4 | 0.79 | 1.0 | 1006 | 20.82 | 0.74 |
| E2 | −12.9 | 0.63 | 1.9 | 270 | 21.52 | 1.01 |
| E3 | −4.7 | 0.57 | 3.3 | 229 | 19.36 | 1.08 |
| E4 | 0.9 | 0.46 | 4.5 | 89 | 17.19 | 0.22 |
| E5 | −20.1 | 0.73 | 0.4 | 936 | 26.02 | 0.96 |
| E6 | −15.4 | 0.53 | 1.0 | 271 | 15.57 | 0.15 |
| E7 | −10.8 | 0.47 | 1.4 | 163 | 18.49 | 1.04 |
| E8 | −20.1 | 0.79 | 0.6 | 1160 | 24.23 | 1.67 |
| E9 | −16.0 | 0.61 | 1.3 | 334 | 20.12 | 0.98 |
| E10 | 0.9 | 0.46 | 1.7 | 181 | 19.31 | 0.35 |
| E11^{a} | N/A | N/A | N/A | N/A | N/A | N/A |
| CE2 | −16.2 | 0.67 | 0.81 | 491 | 26.61 | 1.46 |
| CE3 | 0.6 | 0.49 | 3.14 | 112 | 20.70 | 0.30 |
| CE4 | 10.2 | 0.42 | 6.37 | 53 | 19.54 | 0.40 |
| CE5 | −40 | 0.41 | 0.1 | 702 | 4.38 | 0.17 |
| E12 | −31 | 0.38 | 0.8 | 427 | 8.38 | 0.67 |
| E13 | −22 | 0.27 | 1.1 | 163 | 10.48 | 0.14 |
| E14 | −11 | 0.21 | 2.0 | 74 | 12.34 | 0.20 |
| E15 | −32 | 0.35 | 1.1 | 330 | 6.82 | 0.33 |
| E16 | −22 | 0.26 | 1.7 | 164 | 8.96 | 0.08 |
| E17 | −14 | 0.24 | 3.1 | 82 | 11.06 | 0.13 |
| E18 | −32 | 0.33 | 0.8 | 848 | NA | NA |
| E19^{b} | NA | NA | NA | NA | NA | NA |
| E20^{b} | NA | NA | NA | NA | NA | NA |
| E21 | 2.9 | 0.6 | 1.77 | NA | NA | NA |
| CE6 | −25.5 | 0.52 | 1.22 | 250 | 11.32 | 0.11 |
| CE7 | −10.4 | 0.42 | 1.79 | 81 | 11.77 | 0.10 |

Notably the compositions with an amide monomer of i) or ii) have a lower Tg as compared to the same composition with the same amount (wt. %) of acrylamide monomer.

1. An adhesive composition comprising:
polymerized units of amide monomer selected from the group consisting of 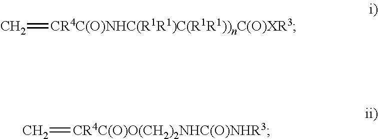
wherein n is an integer of 0 or 1;
R¹ is independently selected from hydrogen or alkyl, aryl, and alkylaryl having 1-10 carbon atoms;
R³ is a group comprising 1-30 carbon atoms selected from alkyl, aryl, alkaryl, or ether and wherein when R³ is alkyl, the alkyl group comprises at least 3 carbon atoms,
R⁴ is H or CH₃; and
X is O or NH; and
at least 50 wt. % of polymerized units of one or more other ethylenically unsaturated monomer(s).

2. The adhesive composition of claim 1 wherein a homopolymer of at least 50 wt. % of the other ethylenically unsaturated monomer(s) have a glass transition temperature (Tg) of less than 25° C.

3. The adhesive composition of claim 1 wherein one or more of the other ethylenically unsaturated monomer(s) have a glass transition temperature greater than 25° C.

4. The adhesive composition of claim 3 wherein the adhesive composition lacks polymerized units of CH₂═CR⁴C(O)NH₂ wherein R4 is hydrogen or methyl.

5. The adhesive composition of claim 1 wherein the adhesive composition further comprises tackifier, plasticizer, or mixtures thereof.

6. The adhesive composition of claim 1 wherein the adhesive further comprises polymerized units of a polar monomer.

7. The adhesive composition of claim 6 wherein the polar monomer comprises hydroxyl or ether groups.

8. The adhesive composition of claim 6 wherein the adhesive lacks polymerized units of an acidic polar monomer.

9. The adhesive composition of claim 1 wherein the adhesive comprises up to 30 wt. % of polymerized amide monomer(s).

10-11. (canceled)

12. The adhesive composition of claim 1 wherein adhesive at a thickness of 100 microns has a haze of less than 5, 4, 3, 2, or 1%.

13. The adhesive composition of claim 1 wherein the adhesive composition is a pressure sensitive adhesive.

14. The adhesive composition of claim 1 wherein adhesive has one or more properties selected from:
a) a Tg of less than 25° C. or 0° C.;
b) a Tan delta at 70° C. of less than 1, 0.9, 0.8, 0.7, 0.6, 0.5, 0.4;
c) a creep compliance at 1000 s of less than 5000, 4000, 3000, 2000, or 1500 l/MPa;
d) peel strength of at least 1, 5, 10, 15, 20, or 25 N/inch (2.54 cm); and
e) a haze of less than 5, 4, 3, 2, or 1%.

15. An article comprising a first substrate and a layer of the curable or cured adhesive composition of claim 1.

16. The article of claim 15 wherein the first substrate is a release liner.

17. The article of claim 15 wherein the first substrate is an organic or inorganic substrate having a haze less than 5, 4, 3, 2, or 1%.

18. The article of claim 15 wherein the layer of curable or cured adhesive is between the first substrate and a second substrate.

19. A method of preparing an article, the method comprising:
forming a laminate comprising a first substrate, a second substrate, and a curable adhesive composition layer according to claim 1 between the first and second substrate; and
exposing the curable adhesive composition layer to ultraviolet or visible light radiation to form a cured adhesive composition layer.

20. A polymerizable adhesive composition comprising:
amide monomer selected from the group consisting of 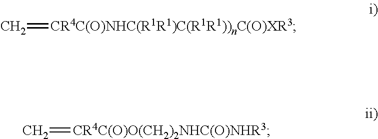
wherein n is an integer of 0 or 1;
R¹ is independently selected from hydrogen or alkyl, aryl, and alkylaryl having 1-10 carbon atoms;
R³ is a group comprising 1-30 carbon atoms selected from alkyl, aryl, alkaryl, or ether and wherein when R³ is alkyl, the alkyl group comprises at least 3 carbon atoms,
R⁴ is H or CH₃; and
X is O or NH; and
at least 50 wt. % of one or more other ethylenically unsaturated monomer(s).

21. The polymerizable composition of claim 20 wherein the monomers are partially cured forming a (meth)acrylic polymer.

22. The polymerizable composition of claim 20 wherein upon curing the composition is a pressure sensitive or heat activatable adhesive or UV activatable adhesive.
